(19) United States
(12) Patent Application Publication
(10) Pub. No.: US 2022/0304011 A1
(43) Pub. Date: Sep. 22, 2022

(54) Control Signaling for Physical Control Channel Reliability Enhancement

(71) Applicant: Apple Inc., Cupertino, CA (US)

(72) Inventors: Yushu Zhang, Beijing (CN); Dawei Zhang, Saratoga, CA (US); Haitong Sun, Irvine, CA (US); Hong He, Cupertino, CA (US); Oghenekome Oteri, San Diego, CA (US); Sigen Ye, Whitehouse Station, NJ (US); Wei Zeng, San Diego, CA (US); Weidong Yang, San Diego, CA (US)

(21) Appl. No.: 17/442,002

(22) PCT Filed: May 15, 2020
(86) PCT No.: PCT/CN2020/090474

§ 371 Date: Sep. 22, 2021

(51) Int. Cl. H04W 72/12; H04W 72/04; H04L 5/00

(52) U.S. Cl. CPC H04W 72/1263; H04W 72/1289; H04W 72/046; H04L 5/0051

(57) ABSTRACT

Control signaling is introduced for enhanced physical control channel (e.g. PDCCH) transmission/reception. A physical control channel may be transmitted and received using multiple beam pairs. The location of the physical control channel may be based on the search space (SS) and its associated control channel resource set (CORESET), with a specified number of transmission configuration indication (TCI) states configured for a CORESET, and/or one SS mapped to a specified number of CORESETs. The TCI states may be selected from a TCI list configured in the corresponding CORESET via radio resource control, and/or may be activated by a media access control (MAC) control element (CE). A base station (e.g. gNB) may configure more than one CORESET-ID for each SS via RRC signaling, applying the configuration for a device specific SS, or both a device specific SS and cell specific SS.

### FIELD OF THE INVENTION

The present application relates to wireless communications, and more particularly to providing control signaling for physical control channel reliability enhancement, for example, physical downlink control channel (PDCCH) reliability enhancement in 3GPP NR communications.

### DESCRIPTION OF THE RELATED ART

Wireless communication systems are rapidly growing in usage. In recent years, wireless devices such as smart phones and tablet computers have become increasingly sophisticated. In addition to supporting telephone calls, many mobile devices (i.e., user equipment devices or UEs) now provide access to the internet, email, text messaging, and navigation using the global positioning system (GPS), and are capable of operating sophisticated applications that utilize these functionalities. Additionally, there exist numerous different wireless communication technologies and standards. Some examples of wireless communication standards include GSM, UMTS (WCDMA, TDS-CDMA), LTE, LTE Advanced (LTE-A), HSPA, 3GPP2 CDMA2000 (e.g., 1×RTT, 1×EV-DO, HRPD, eHRPD), IEEE 802.11 (WLAN or Wi-Fi), IEEE 802.16 (WiMAX), BLUETOOTH™, etc. A proposed next telecommunications standard moving beyond the International Mobile Telecommunications-Advanced (IMT-Advanced) Standards is 5th generation mobile networks or 5th generation wireless systems, referred to as 3GPP NR (otherwise known as 5G-NR for 5G New Radio, also simply referred to as NR). NR proposes a higher capacity for a higher density of mobile broadband users, also supporting device-to-device, ultra-reliable, and massive machine communications, as well as lower latency and lower battery consumption, than LTE standards.

3GPP LTE/NR defines a number of downlink (DL) physical channels, categorized as transport or control channels, to carry information blocks received from the MAC and higher layers. 3GPP LTE/NR also defines physical layer channels for the uplink (UL). The Physical Downlink Shared Channel (PDSCH) is a DL transport channel, and is the main data-bearing channel allocated to users on a dynamic and opportunistic basis. The PDSCH carries data in Transport Blocks (TB) corresponding to a media access control protocol data unit (MAC PDU), passed from the MAC layer to the physical (PHY) layer once per Transmission Time Interval (TTI). The PDSCH is also used to transmit broadcast information such as System Information Blocks (SIB) and paging messages.

The Physical Downlink Control Channel (PDCCH) is a DL control channel that carries the resource assignment for UEs that are contained in a Downlink Control Information (DCI) message. For example, the DCI may include a transmission configuration indication (TCI) relating to beamforming, with the TCI including configurations such as quasi-co-located (QCL) relationships between the downlink reference signals (DL-RSs) in one Channel State Information RS (CSI-RS) set and the PDSCH Demodulation Reference Signal (DMRS) ports. Each TCI state can contain parameters for configuring a QCL relationship between one or two downlink reference signals and the DMRS ports of the PDSCH, the DMRS port of PDCCH or the CSI-RS port(s) of a CSI-RS resource. Multiple PDCCHs can be transmitted in the same subframe using Control Channel Elements (CCE), each of which is a set of resource elements known as Resource Element Groups (REG). The PDCCH can employ quadrature phase-shift keying (QPSK) modulation, with a specified number (e.g. four) of QPSK symbols mapped to each REG. Furthermore, a specified number (e.g. 1, 2, 4, or 8) of CCEs can be used for a UE, depending on channel conditions, to ensure sufficient robustness.

The Physical Uplink Shared Channel (PUSCH) is a UL channel shared by all devices (user equipment, UE) in a radio cell to transmit user data to the network. The scheduling for all UEs is under control of the base station (e.g. eNB or gNB). The base station uses the uplink scheduling grant (e.g. DCI format 0) to inform the UE about resource block (RB) assignment, and the modulation and coding scheme to be used. PUSCH typically supports QPSK and quadrature amplitude modulation (QAM). In addition to user data, the PUSCH also carries any control information necessary to decode the information, such as transport format indicators and multiple-in multiple-out (MIMO) parameters. Control data is multiplexed with information data prior to digital Fourier transform (DFT) spreading.

As noted above, downlink data transmission takes place over the physical channel PDSCH, while uplink data transmission takes place over the UL channel PUSCH. As also mentioned above, these two channels convey the transport blocks of data in addition to some MAC control and system information. To support the transmission of DL and UL transport channels, Downlink Shared Channel (DLSCH) and Uplink Shared Channel (UL-SCH) control signaling is used. The control information is sent in (or over) the PDCCH and it contains DL resource assignment and UL grant information. PDCCH is typically transmitted at the beginning of every subframe in the first OFDM symbols. Support for efficient and effective transmission of PDCCH is therefore extremely important.

Other corresponding issues related to the prior art will become apparent to one skilled in the art after comparing such prior art with the disclosed embodiments as described herein.

### SUMMARY OF THE INVENTION

Embodiments are presented herein of, inter alia, of methods for implementing control signaling for physical control channel reliability enhancement in wireless communications, for example for PDCCH enhancement in 3GPP New Radio (NR) communications. Embodiments are further presented herein for wireless communication systems containing user equipment (UE) devices and/or base stations communicating with each other within the wireless communication systems.

Pursuant to the above, control signaling is introduced for enhanced physical control channel (e.g. PDCCH) transmission/reception. A PDCCH may be transmitted and received using multiple beam pairs. The PDCCH location may be based on a search space (SS) and its associated control channel resource set (CORESET), with up to a specified number (N) of transmission configuration indication (TCI) states configured for a CORESET, and/or one SS mapped to up to a specified number (N) of CORESETs.

Accordingly, a device may receive a physical control channel using multiple beam pairs, with the time and frequency resources used to carry the physical control channel based on a search space and its associated one or more control channel resource CORESETs, with a specified first number of TCI states configured for a corresponding CORESET of the one or more the associated CORESETs, and/or the search space mapped to a specified second number of CORESETs of the associated one or more CORESETs. The specified first number of TCI states may be selected from a TCI (states) list configured in the corresponding CORESET via radio resource control, and/or may be activated by a media access control (MAC) control element (CE). The MAC CE may activate the specified first number of TCI states for the corresponding CORESET with a same ID in each cell of a group of serving cells, or for all CORESETs in the group of serving cells. The group of serving cells may be configured via radio resource control signaling as determined by capabilities of the device.

The device receiving the physical control channel according to the specified first number of TCI states may include the device receiving the physical control channel using the time and frequency resources indicated by the search space and the corresponding CORESET, based on the specified first number of TCI states, or receiving multiple instances of the physical control channel in the time and frequency resources indicated by the search space and the corresponding CORESET, with each instance of the multiple instances associated with a different TCI state of the specified first number of TCI states. The specified first number of TCI states may be multiplexed according to frequency division multiplexing (FDM), time division multiplexing (TDM), and/or spatial division multiplexing (SDM). Any one or more of the FDM, TDM, or SDM may be configured via higher layer signaling and/or parameters configured in the corresponding CORESET. In some embodiments, the parameters may include precoder granularity and/or duration.

The specified number of TCI states may be multiplexed according to FDM when the precoder granularity is commensurate with a resource element group level, according to TDM when the precoder granularity represents a contiguous resource block (RB) configuration and the duration is configured with more than one symbol, and according to SDM when the precoder granularity represents a contiguous RB configuration and the duration is configured with one symbol. When the precoder granularity is commensurate with a resource element group (REG) level, even REGs may be associated with a first TCI, and odd REGs may be associated with a second TCI. The granularity of frequency resources mapped to a TCI may be configured by a radio resource control parameter.

In some embodiments, a first TCI may be mapped to a first number of symbols of the time resources and a second TCI may be mapped to remaining symbols of the time resources. In some embodiments, a first TCI may be mapped to even symbols of the time resources and a second TCI may be mapped to odd symbols of the time resources. In some embodiments, each TCI may be mapped to a respective demodulation reference signal (DMRS) port of a specified number of DMRS ports.

A base station (e.g. gNB) may configure more than one CORESET identifier via RRC signaling for each SS. The configuration may be applied to device specific search space and/or cell specific search space. In some embodiments, the starting symbol of the time resources for each of the specified second number of CORESETs may be configured separately in the search space. In some embodiments, the starting symbol index of the time resources may be determined by a duration of each of the specified second number of CORESETs and a corresponding CORESET identifier.

Note that the techniques described herein may be implemented in and/or used with a number of different types of devices, including but not limited to, base stations, access points, cellular phones, portable media players, tablet computers, wearable devices, and various other computing devices.

This Summary is intended to provide a brief overview of some of the subject matter described in this document. Accordingly, it will be appreciated that the above-described features are merely examples and should not be construed to narrow the scope or spirit of the subject matter described herein in any way. Other features, aspects, and advantages of the subject matter described herein will become apparent from the following Detailed Description, Figures, and Claims.

### BRIEF DESCRIPTION OF THE DRAWINGS

FIG. 1 illustrates an exemplary (and simplified) wireless communication system, according to some embodiments;

FIG. 2 illustrates an exemplary base station in communication with an exemplary wireless user equipment (UE) device, according to some embodiments;

FIG. 3 illustrates an exemplary block diagram of a UE, according to some embodiments;

FIG. 4 illustrates an exemplary block diagram of a base station, according to some embodiments;

FIG. 5 shows an exemplary simplified block diagram illustrative of cellular communication circuitry, according to some embodiments;

FIG. 6 shows an exemplary diagram illustrating a possible physical downlink control channel (PDCCH) location based on a search space (SS) and its associated control resource set (CORESET);

FIG. 7 shows an exemplary diagram illustrating a possible PDCCH location based on an SS and its associated CORESET with multiple transmission configuration indication (TCI) states configured for a CORESET, according to some embodiments;

FIG. 8 shows an exemplary diagram illustrating a possible PDCCH location based on an SS and its associated CORESETs with one SS mapped to multiple CORESETs, according to some embodiments; and

FIG. 9 shows an exemplary diagram illustrating examples of multiple CORESETs configured for a single SS, according to some embodiments.

While features described herein are susceptible to various modifications and alternative forms, specific embodiments thereof are shown by way of example in the drawings and are herein described in detail. It should be understood, however, that the drawings and detailed description thereto are not intended to be limiting to the particular form disclosed, but on the contrary, the intention is to cover all modifications, equivalents and alternatives falling within the spirit and scope of the subject matter as defined by the appended claims.

### DETAILED DESCRIPTION OF THE EMBODIMENTS

### Acronyms

Various acronyms are used throughout the present application. Definitions of the most prominently used acronyms that may appear throughout the present application are provided below:
APR: Applications Processor
BS: Base Station
BSR: Buffer Size Report
CMR: Change Mode Request
CORESET: Control Channel Resource Set
CRC: Cyclic Redundancy Check
CSI: Channel State Information
DCI: Downlink Control Information
DL: Downlink (from BS to UE)
DYN: Dynamic
FDM: Frequency Division Multiplexing
FT: Frame Type
GC-PDCCH: Group Common Physical Downlink Control Channel
GPRS: General Packet Radio Service
GSM: Global System for Mobile Communication
GTP: GPRS Tunneling Protocol
IR: Initialization and Refresh state
LAN: Local Area Network
LTE: Long Term Evolution
MAC: Media Access Control
MAC-CE: MAC Control Element
MIB: Master Information Block
MIMO: Multiple-In Multiple-Out
OSI: Open System Interconnection
PBCH: Physical Broadcast Channel
PDCCH: Physical Downlink Control Channel
PDCP: Packet Data Convergence Protocol
PDN: Packet Data Network
PDSCH: Physical Downlink Shared Channel
PDU: Protocol Data Unit
QCL: Quasi Co-Location
RACH: Random Access Procedure
RAT: Radio Access Technology
RB: Resource Block
RF: Radio Frequency
RMSI: Remaining Minimum System Information
ROHC: Robust Header Compression
RRC: Radio Resource Control
RS: Reference Signal (Symbol)
RSI: Root Sequence Indicator
RTP: Real-time Transport Protocol
RX: Reception/Receive
SDM: Spatial Division Multiplexing
SID: System Identification Number
SGW: Serving Gateway
SRS: Sounding Reference Signal
SS: Search Space
SSB: Synchronization Signal Block
TBS: Transport Block Size
TCI: Transmission Configuration Indication
TDM: Time Division Multiplexing
TRS: Tracking Reference Signal
TX: Transmission/Transmit
UE: User Equipment
UL: Uplink (from UE to BS)
UMTS: Universal Mobile Telecommunication System
Wi-Fi: Wireless Local Area Network (WLAN) RAT based on the Institute of Electrical and Electronics Engineers' (IEEE) 802.11 standards
WLAN: Wireless LAN

### Terms

The following is a glossary of terms that may appear in the present application:

Memory Medium—Any of various types of memory devices or storage devices. The term “memory medium” is intended to include an installation medium, e.g., a CD-ROM, floppy disks, or tape device; a computer system memory or random access memory such as DRAM, DDR RAM, SRAM, EDO RAM, Rambus RAM, etc.; a non-volatile memory such as a Flash, magnetic media, e.g., a hard drive, or optical storage; registers, or other similar types of memory elements, etc. The memory medium may comprise other types of memory as well or combinations thereof. In addition, the memory medium may be located in a first computer system in which the programs are executed, or may be located in a second different computer system which connects to the first computer system over a network, such as the Internet. In the latter instance, the second computer system may provide program instructions to the first computer system for execution. The term “memory medium” may include two or more memory mediums which may reside in different locations, e.g., in different computer systems that are connected over a network. The memory medium may store program instructions (e.g., embodied as computer programs) that may be executed by one or more processors.

Carrier Medium—a memory medium as described above, as well as a physical transmission medium, such as a bus, network, and/or other physical transmission medium that conveys signals such as electrical, electromagnetic, or digital signals.

Programmable Hardware Element—Includes various hardware devices comprising multiple programmable function blocks connected via a programmable interconnect. Examples include FPGAs (Field Programmable Gate Arrays), PLDs (Programmable Logic Devices), FPOAs (Field Programmable Object Arrays), and CPLDs (Complex PLDs). The programmable function blocks may range from fine grained (combinatorial logic or look up tables) to coarse grained (arithmetic logic units or processor cores). A programmable hardware element may also be referred to as “reconfigurable logic”.

Computer System (or Computer)—any of various types of computing or processing systems, including a personal computer system (PC), mainframe computer system, workstation, network appliance, Internet appliance, personal digital assistant (PDA), television system, grid computing system, or other device or combinations of devices. In general, the term “computer system” may be broadly defined to encompass any device (or combination of devices) having at least one processor that executes instructions from a memory medium.

User Equipment (UE) (or “UE Device”)— any of various types of computer systems devices which perform wireless communications. Also referred to as wireless communication devices, many of which may be mobile and/or portable. Examples of UE devices include mobile telephones or smart phones (e.g., iPhone™, Android™-based phones) and tablet computers such as iPad™, Samsung Galaxy™, etc., gaming devices (e.g. Sony PlayStation™, Microsoft XBox™, etc.), portable gaming devices (e.g., Nintendo DS™, PlayStation Portable™, Gameboy Advance™, iPod™), laptops, wearable devices (e.g. Apple Watch™, Google Glass™), PDAs, portable Internet devices, music players, data storage devices, or other handheld devices, unmanned aerial vehicles (e.g., drones) and unmanned aerial controllers, etc. Various other types of devices would fall into this category if they include Wi-Fi or both cellular and Wi-Fi communication capabilities and/or other wireless communication capabilities, for example over short-range radio access technologies (SRATs) such as BLUETOOTH™, etc. In general, the term “UE” or “UE device” may be broadly defined to encompass any electronic, computing, and/or telecommunications device (or combination of devices) which is capable of wireless communication and may also be portable/mobile.

Wireless Device (or wireless communication device)—any of various types of computer systems devices which performs wireless communications using WLAN communications, SRAT communications, Wi-Fi communications and the like. As used herein, the term “wireless device” may refer to a UE device, as defined above, or to a stationary device, such as a stationary wireless client or a wireless base station. For example a wireless device may be any type of wireless station of an 802.11 system, such as an access point (AP) or a client station (UE), or any type of wireless station of a cellular communication system communicating according to a cellular radio access technology (e.g. LTE, CDMA, GSM), such as a base station or a cellular telephone, for example.

Communication Device—any of various types of computer systems or devices that perform communications, where the communications can be wired or wireless. A communication device can be portable (or mobile) or may be stationary or fixed at a certain location. A wireless device is an example of a communication device. A UE is another example of a communication device.

Base Station (BS)—The term “Base Station” has the full breadth of its ordinary meaning, and at least includes a wireless communication station installed at a fixed location and used to communicate as part of a wireless telephone system or radio system.

Processor—refers to various elements (e.g. circuits) or combinations of elements that are capable of performing a function in a device, e.g. in a user equipment device or in a cellular network device. Processors may include, for example: general purpose processors and associated memory, portions or circuits of individual processor cores, entire processor cores or processing circuit cores, processing circuit arrays or processor arrays, circuits such as ASICs (Application Specific Integrated Circuits), programmable hardware elements such as a field programmable gate array (FPGA), as well as any of various combinations of the above.

Channel—a medium used to convey information from a sender (transmitter) to a receiver. It should be noted that since characteristics of the term “channel” may differ according to different wireless protocols, the term “channel” as used herein may be considered as being used in a manner that is consistent with the standard of the type of device with reference to which the term is used. In some standards, channel widths may be variable (e.g., depending on device capability, band conditions, etc.). For example, LTE may support scalable channel bandwidths from 1.4 MHz to 20 MHz. In contrast, WLAN channels may be 22 MHz wide while Bluetooth channels may be 1 Mhz wide. Other protocols and standards may include different definitions of channels. Furthermore, some standards may define and use multiple types of channels, e.g., different channels for uplink or downlink and/or different channels for different uses such as data, control information, etc.

Band (or Frequency Band)—The term “band” has the full breadth of its ordinary meaning, and at least includes a section of spectrum (e.g., radio frequency spectrum) in which channels are used or set aside for the same purpose. Furthermore, “frequency band” is used to denote any interval in the frequency domain, delimited by a lower frequency and an upper frequency. The term may refer to a radio band or an interval of some other spectrum. A radio communications signal may occupy a range of frequencies over which (or where) the signal is carried. Such a frequency range is also referred to as the bandwidth of the signal. Thus, bandwidth refers to the difference between the upper frequency and lower frequency in a continuous band of frequencies. A frequency band may represent one communication channel or it may be subdivided into multiple communication channels. Allocation of radio frequency ranges to different uses is a major function of radio spectrum allocation.

Wi-Fi—The term “Wi-Fi” has the full breadth of its ordinary meaning, and at least includes a wireless communication network or RAT that is serviced by wireless LAN (WLAN) access points and which provides connectivity through these access points to the Internet. Most modern Wi-Fi networks (or WLAN networks) are based on IEEE 802.11 standards and are marketed under the name “Wi-Fi”. A Wi-Fi (WLAN) network is different from a cellular network.

Automatically—refers to an action or operation performed by a computer system (e.g., software executed by the computer system) or device (e.g., circuitry, programmable hardware elements, ASICs, etc.), without user input directly specifying or performing the action or operation. Thus the term “automatically” is in contrast to an operation being manually performed or specified by the user, where the user provides input to directly perform the operation. An automatic procedure may be initiated by input provided by the user, but the subsequent actions that are performed “automatically” are not specified by the user, i.e., are not performed “manually”, where the user specifies each action to perform. For example, a user filling out an electronic form by selecting each field and providing input specifying information (e.g., by typing information, selecting check boxes, radio selections, etc.) is filling out the form manually, even though the computer system must update the form in response to the user actions. The form may be automatically filled out by the computer system where the computer system (e.g., software executing on the computer system) analyzes the fields of the form and fills in the form without any user input specifying the answers to the fields. As indicated above, the user may invoke the automatic filling of the form, but is not involved in the actual filling of the form (e.g., the user is not manually specifying answers to fields but rather they are being automatically completed). The present specification provides various examples of operations being automatically performed in response to actions the user has taken.

Approximately—refers to a value that is almost correct or exact. For example, approximately may refer to a value that is within 1 to 10 percent of the exact (or desired) value. It should be noted, however, that the actual threshold value (or tolerance) may be application dependent. For example, in some embodiments, “approximately” may mean within 0.1% of some specified or desired value, while in various other embodiments, the threshold may be, for example, 2%, 3%, 5%, and so forth, as desired or as required by the particular application.

Concurrent—refers to parallel execution or performance, where tasks, processes, or programs are performed in an at least partially overlapping manner. For example, concurrency may be implemented using “strong” or strict parallelism, where tasks are performed (at least partially) in parallel on respective computational elements, or using “weak parallelism”, where the tasks are performed in an interleaved manner, e.g., by time multiplexing of execution threads.

Station (STA)—The term “station” herein refers to any device that has the capability of communicating wirelessly, e.g. by using the 802.11 protocol. A station may be a laptop, a desktop PC, PDA, access point or Wi-Fi phone or any type of device similar to a UE. An STA may be fixed, mobile, portable or wearable. Generally in wireless networking terminology, a station (STA) broadly encompasses any device with wireless communication capabilities, and the terms station (STA), wireless client (UE) and node (BS) are therefore often used interchangeably.

Configured to—Various components may be described as “configured to” perform a task or tasks. In such contexts, “configured to” is a broad recitation generally meaning “having structure that” performs the task or tasks during operation. As such, the component can be configured to perform the task even when the component is not currently performing that task (e.g., a set of electrical conductors may be configured to electrically connect a module to another module, even when the two modules are not connected). In some contexts, “configured to” may be a broad recitation of structure generally meaning “having circuitry that” performs the task or tasks during operation. As such, the component can be configured to perform the task even when the component is not currently on. In general, the circuitry that forms the structure corresponding to “configured to” may include hardware circuits.

Transmission Scheduling—Refers to the scheduling of transmissions, such as wireless transmissions. In some implementations of cellular radio communications, signal and data transmissions may be organized according to designated time units of specific duration during which transmissions take place. As used herein, the term “slot” has the full extent of its ordinary meaning, and at least refers to a smallest (or minimum) scheduling time unit in wireless communications. For example, in 3GPP LTE, transmissions are divided into radio frames, each radio frame being of equal (time) duration (e.g. 10 ms). A radio frame in 3GPP LTE may be further divided into a specified number of (e.g. ten) subframes, each subframe being of equal time duration, with the subframes designated as the smallest (minimum) scheduling unit, or the designated time unit for a transmission. Thus, in a 3GPP LTE example, a “subframe” may be considered an example of a “slot” as defined above. Similarly, a smallest (or minimum) scheduling time unit for 5G NR (or NR, for short) transmissions is referred to as a “slot”. In different communication protocols the smallest (or minimum) scheduling time unit may also be named differently.

Resources—The term “resource” has the full extent of its ordinary meaning and may refer to frequency resources and time resources used during wireless communications. As used herein, a resource element (RE) refers to a specific amount or quantity of a resource. For example, in the context of a time resource, a resource element may be a time period of specific length. In the context of a frequency resource, a resource element may be a specific frequency bandwidth, or a specific amount of frequency bandwidth, which may be centered on a specific frequency. As one specific example, a resource element may refer to a resource unit of 1 symbol (in reference to a time resource, e.g. a time period of specific length) per 1 subcarrier (in reference to a frequency resource, e.g. a specific frequency bandwidth, which may be centered on a specific frequency). A resource element group (REG) has the full extent of its ordinary meaning and at least refers to a specified number of consecutive resource elements. In some implementations, a resource element group may not include resource elements reserved for reference signals. A control channel element (CCE) refers to a group of a specified number of consecutive REGs. A resource block (RB) refers to a specified number of resource elements made up of a specified number of subcarriers per specified number of symbols. Each RB may include a specified number of subcarriers. A resource block group (RBG) refers to a unit including multiple RBs. The number of RBs within one RBG may differ depending on the system bandwidth.

Various components may be described as performing a task or tasks, for convenience in the description. Such descriptions should be interpreted as including the phrase “configured to.” Reciting a component that is configured to perform one or more tasks is expressly intended not to invoke 35 U.S.C. § 112, paragraph six, interpretation for that component.

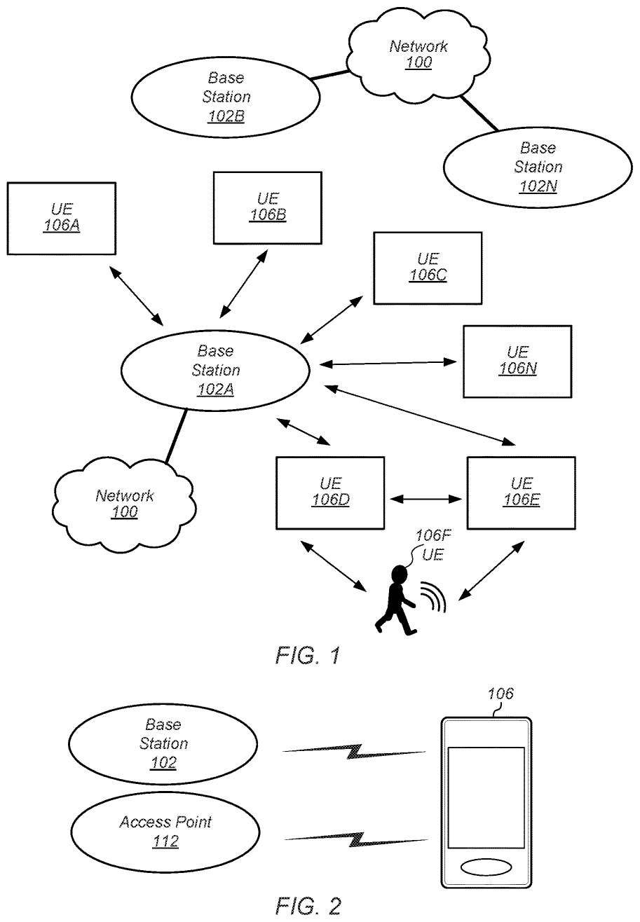

### FIGS. 1 and 2—Exemplary Communication Systems

FIG. 1 illustrates an exemplary (and simplified) wireless communication system, according to some embodiments. It is noted that the system of FIG. 1 is merely one example of a possible system, and embodiments may be implemented in any of various systems, as desired.

As shown, the exemplary wireless communication system includes base stations 102A through 102N, also collectively referred to as base station(s) 102 or base station 102. As shown in FIG. 1, base station 102A communicates over a transmission medium with one or more user devices 106A through 106N. Each of the user devices may be referred to herein as a “user equipment” (UE) or UE device. Thus, the user devices 106A through 106N are referred to as UEs or UE devices, and are also collectively referred to as UE(s) 106 or UE 106. Various ones of the UE devices may operate using control signaling that facilitates physical control channel (e.g. PDCCH) reliability enhancement, according to various embodiments disclosed herein.

The base station 102A may be a base transceiver station (BTS) or cell site, and may include hardware that enables wireless communication with the UEs 106A through 106N. The base station 102A may also be equipped to communicate with a network 100, e.g., a core network of a cellular service provider, a telecommunication network such as a public switched telephone network (PSTN), and/or the Internet, neutral host or various CBRS (Citizens Broadband Radio Service) deployments, among various possibilities. Thus, the base station 102A may facilitate communication between the user devices and/or between the user devices and the network 100. In particular, the cellular base station 102A may provide UEs 106 with various telecommunication capabilities, such as voice, SMS and/or data services. The communication area (or coverage area) of the base station may be referred to as a “cell.” It should also be noted that “cell” may also refer to a logical identity for a given coverage area at a given frequency. In general, any independent cellular wireless coverage area may be referred to as a “cell”. In such cases a base station may be situated at particular confluences of three cells. The base station, in this uniform topology, may serve three 120 degree beam width areas referenced as cells. Also, in case of carrier aggregation, small cells, relays, etc. may each represent a cell. Thus, in carrier aggregation in particular, there may be primary cells and secondary cells which may service at least partially overlapping coverage areas but on different respective frequencies. For example, a base station may serve any number of cells, and cells served by a base station may or may not be collocated (e.g. remote radio heads). As also used herein, from the perspective of UEs, a base station may sometimes be considered as representing the network insofar as uplink and downlink communications of the UE are concerned. Thus, a UE communicating with one or more base stations in the network may also be interpreted as the UE communicating with the network, and may further also be considered at least a part of the UE communicating on the network or over the network.

The base station(s) 102 and the user devices may be configured to communicate over the transmission medium using any of various radio access technologies (RATs), also referred to as wireless communication technologies, or telecommunication standards, such as GSM, UMTS (WCDMA), LTE, LTE-Advanced (LTE-A), LAA/LTE-U, 5G-NR (NR, for short), 3GPP2 CDMA2000 (e.g., 1×RTT, 1×EV-DO, HRPD, eHRPD), Wi-Fi, WiMAX etc. Note that if a base station(s) 102 are implemented in the context of LTE, it may alternately be referred to as an ‘eNodeB’ or ‘eNB’. Note that if the base station 102A is implemented in the context of 5G NR, it may alternately be referred to as ‘gNodeB’ or ‘gNB’. In some embodiments, the base station(s) 102 may implement control signaling for enhancing the reliability of physical control channel (e.g. PDCCH) transmissions and reception, as described herein. Depending on a given application or specific considerations, for convenience some of the various different RATs may be functionally grouped according to an overall defining characteristic. For example, all cellular RATs may be collectively considered as representative of a first (form/type of) RAT, while Wi-Fi communications may be considered as representative of a second RAT. In other cases, individual cellular RATs may be considered individually as different RATs. For example, when differentiating between cellular communications and Wi-Fi communications, “first RAT” may collectively refer to all cellular RATs under consideration, while “second RAT” may refer to Wi-Fi. Similarly, when applicable, different forms of Wi-Fi communications (e.g. over 2.4 GHz vs. over 5 GHz) may be considered as corresponding to different RATs. Furthermore, cellular communications performed according to a given RAT (e.g. LTE or NR) may be differentiated from each other on the basis of the frequency spectrum in which those communications are conducted. For example, LTE or NR communications may be performed over a primary licensed spectrum as well as over a secondary spectrum such as an unlicensed spectrum and/or spectrum that was assigned to Citizens Broadband Radio Service (CBRS). Overall, the use of various terms and expressions will always be clearly indicated with respect to and within the context of the various applications/embodiments under consideration.

As shown, the base station 102A may also be equipped to communicate with a network 100 (e.g., a core network of a cellular service provider, a telecommunication network such as a public switched telephone network (PSTN), and/or the Internet, among various possibilities). Thus, the base station 102A may facilitate communication between the user devices and/or between the user devices and the network 100. In particular, the cellular base station 102A may provide UEs 106 with various telecommunication capabilities, such as voice, SMS and/or data services. Base station 102A and other similar base stations (such as base stations 102B . . . 102N) operating according to the same or a different cellular communication standard may thus be provided as a network of cells, which may provide continuous or nearly continuous overlapping service to UEs 106A-106N and similar devices over a geographic area via one or more cellular communication standards.

Thus, while base station 102A may act as a “serving cell” for UEs 106A-106N as illustrated in FIG. 1, each one of UE(s) 106 may also be capable of receiving signals from (and possibly within communication range of) one or more other cells (which might be provided by base stations 102B-102N and/or any other base stations), which may be referred to as “neighboring cells”. Such cells may also be capable of facilitating communication between user devices and/or between user devices and the network 100. Such cells may include “macro” cells, “micro” cells, “pico” cells, and/or cells which provide any of various other granularities of service area size. For example, base stations 102A-102B illustrated in FIG. 1 might be macro cells, while base station 102N might be a micro cell. Other configurations are also possible.

In some embodiments, base station 102A may be a next generation base station, e.g., a 5G New Radio (5G NR) base station, or “gNB”. In some embodiments, a gNB may be connected to a legacy evolved packet core (EPC) network and/or to a NR core (NRC) network. In addition, a gNB cell may include one or more transmission and reception points (TRPs). In addition, a UE capable of operating according to 5G NR may be connected to one or more TRPs within one or more gNBs.

As mentioned above, UE(s) 106 may be capable of communicating using multiple wireless communication standards. For example, a UE might be configured to communicate using any or all of a 3GPP cellular communication standard (such as LTE or NR) or a 3GPP2 cellular communication standard (such as a cellular communication standard in the CDMA2000 family of cellular communication standards). Base station 102 and other similar base stations operating according to the same or a different cellular communication standard may thus be provided as one or more networks of cells, which may provide continuous or nearly continuous overlapping service to UE 106 and similar devices over a wide geographic area via one or more cellular communication standards.

The UE(s) 106 might also or alternatively be configured to communicate using WLAN, BLUETOOTH™, BLUETOOTH™ Low-Energy, one or more global navigational satellite systems (GNSS, e.g., GPS or GLONASS), one and/or more mobile television broadcasting standards (e.g., ATSC-M/H or DVB-H), etc. Other combinations of wireless communication standards (including more than two wireless communication standards) are also possible. Furthermore, UE(s) 106 may also communicate with Network 100, through one or more base stations or through other devices, stations, or any appliances not explicitly shown but considered to be part of Network 100. UE(s) 106 communicating with a network may therefore be interpreted as the UEs 106 communicating with one or more network nodes considered to be a part of the network and which may interact with the UE(s) 106 to conduct communications with the UE(s) 106 and in some cases affect at least some of the communication parameters and/or use of communication resources of the UE(s) 106.

Furthermore, as also illustrated in FIG. 1, at least some of the UE(s) 106, e.g. 106D and 106E may represent vehicles communicating with each other and with base station 102A, via cellular communications such as 3GPP LTE and/or 5G-NR for example. In addition, UE 106F may represent a pedestrian who is communicating and/or interacting with the vehicles represented by UEs 106D and 106E in a similar manner. Further aspects of vehicles communicating in a network exemplified in FIG. 1 are disclosed in the context of vehicle-to-everything (V2X) communications such as the communications specified by 3GPP TS 22.185 V 14.3.0, among others.

FIG. 2 illustrates an exemplary user equipment 106 (e.g., one of the devices 106A through 106N) in communication with the base station 102 and an access point 112, according to some embodiments. The UE 106 may be a device with both cellular communication capability and non-cellular communication capability (e.g., BLUETOOTH™, Wi-Fi, and so forth) such as a mobile phone, a hand-held device, a computer or a tablet, or virtually any type of wireless device. The UE 106 may include a processor that is configured to execute program instructions stored in memory. The UE 106 may perform any of the method embodiments described herein by executing such stored instructions. Alternatively, or in addition, the UE 106 may include a programmable hardware element such as an FPGA (field-programmable gate array) that is configured to perform any of the method embodiments described herein, or any portion of any of the method embodiments described herein. The UE 106 may be configured to communicate using any of multiple wireless communication protocols. For example, the UE 106 may be configured to communicate using two or more of CDMA2000, LTE, LTE-A, NR, WLAN, or GNSS. Other combinations of wireless communication standards are also possible.

The UE 106 may include one or more antennas for communicating using one or more wireless communication protocols according to one or more RAT standards, e.g. those previously mentioned above. In some embodiments, the UE 106 may share one or more parts of a receive chain and/or transmit chain between multiple wireless communication standards. The shared radio may include a single antenna, or may include multiple antennas (e.g., for MIMO) for performing wireless communications. Alternatively, the UE 106 may include separate transmit and/or receive chains (e.g., including separate antennas and other radio components) for each wireless communication protocol with which it is configured to communicate. As another alternative, the UE 106 may include one or more radios or radio circuitry which are shared between multiple wireless communication protocols, and one or more radios which are used exclusively by a single wireless communication protocol. For example, the UE 106 may include a shared radio for communicating using either of LTE or CDMA2000 1×RTT or NR, and separate radios for communicating using each of Wi-Fi and BLUETOOTH™. Other configurations are also possible.

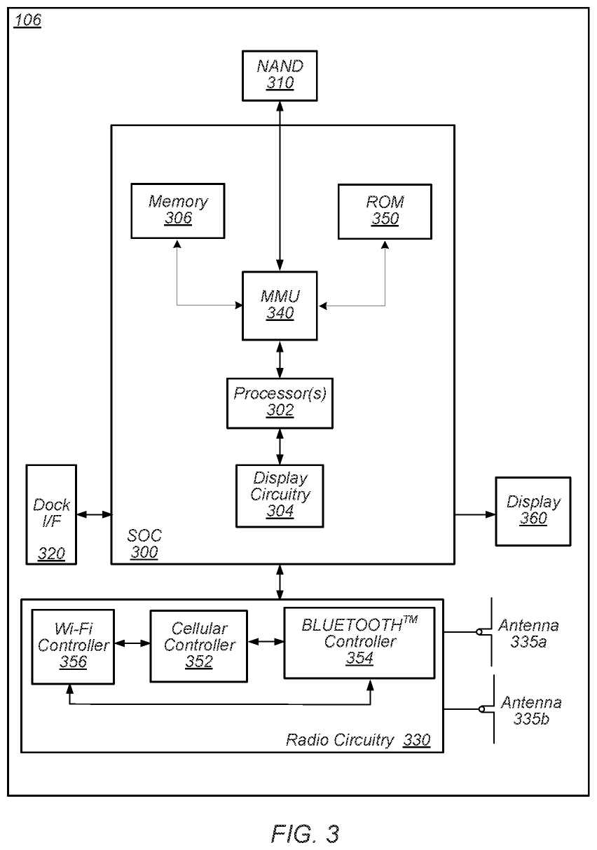

### FIG. 3—Block Diagram of an Exemplary UE

FIG. 3 illustrates a block diagram of an exemplary UE 106, according to some embodiments. As shown, the UE 106 may include a system on chip (SOC) 300, which may include portions for various purposes. For example, as shown, the SOC 300 may include processor(s) 302 which may execute program instructions for the UE 106 and display circuitry 304 which may perform graphics processing and provide display signals to the display 360. The processor(s) 302 may also be coupled to memory management unit (MMU) 340, which may be configured to receive addresses from the processor(s) 302 and translate those addresses to locations in memory (e.g., memory 306, read only memory (ROM) 350, NAND flash memory 310) and/or to other circuits or devices, such as the display circuitry 304, radio circuitry 330, connector I/F 320, and/or display 360. The MMU 340 may be configured to perform memory protection and page table translation or set up. In some embodiments, the MMU 340 may be included as a portion of the processor(s) 302.

As shown, the SOC 300 may be coupled to various other circuits of the UE 106. For example, the UE 106 may include various types of memory (e.g., including NAND flash 310), a connector interface 320 (e.g., for coupling to the computer system), the display 360, and wireless communication circuitry (e.g., for LTE, LTE-A, NR, CDMA2000, BLUETOOTH™, Wi-Fi, GPS, etc.). The UE device 106 may include at least one antenna (e.g. 335a), and possibly multiple antennas (e.g. illustrated by antennas 335a and 335b), for performing wireless communication with base stations and/or other devices. Antennas 335a and 335b are shown by way of example, and UE device 106 may include fewer or more antennas. Overall, the one or more antennas are collectively referred to as antenna(s) 335. For example, the UE device 106 may use antenna(s) 335 to perform the wireless communication with the aid of radio circuitry 330. As noted above, the UE may be configured to communicate wirelessly using multiple wireless communication standards in some embodiments.

As further described herein, the UE 106 (and/or base station(s) 102) may include hardware and software components for operating using control signaling that enhances physical control channel (e.g. PDCCH) transmission and reception, as further detailed herein. The processor(s) 302 of the UE device 106 may be configured to implement part or all of the methods described herein, e.g., by executing program instructions stored on a memory medium (e.g., a non-transitory computer-readable memory medium). In other embodiments, processor(s) 302 may be configured as a programmable hardware element, such as an FPGA (Field Programmable Gate Array), or as an ASIC (Application Specific Integrated Circuit). Furthermore, processor(s) 302 may be coupled to and/or may interoperate with other components as shown in FIG. 3, to operate using control signaling that enhances physical control channel (e.g. PDCCH) reliability according to various embodiments disclosed herein. Processor(s) 302 may also implement various other applications and/or end-user applications running on UE 106.

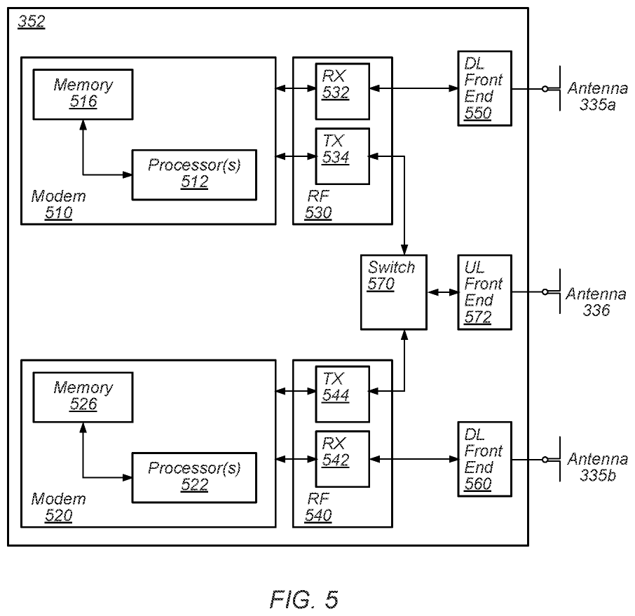

In some embodiments, radio circuitry 330 may include separate controllers dedicated to controlling communications for various respective RAT standards. For example, as shown in FIG. 3, radio circuitry 330 may include a Wi-Fi controller 356, a cellular controller (e.g. LTE and/or NR controller) 352, and BLUETOOTH™ controller 354, and in at least some embodiments, one or more or all of these controllers may be implemented as respective integrated circuits (ICs or chips, for short) in communication with each other and with SOC 300 (and more specifically with processor(s) 302). For example, Wi-Fi controller 356 may communicate with cellular controller 352 over a cell-ISM link or WCI interface, and/or BLUETOOTH™ controller 354 may communicate with cellular controller 352 over a cell-ISM link, etc. While three separate controllers are illustrated within radio circuitry 330, other embodiments have fewer or more similar controllers for various different RATs that may be implemented in UE device 106. For example, at least one exemplary block diagram illustrative of some embodiments of cellular controller 352 is shown in FIG. 5 and will be further described below.

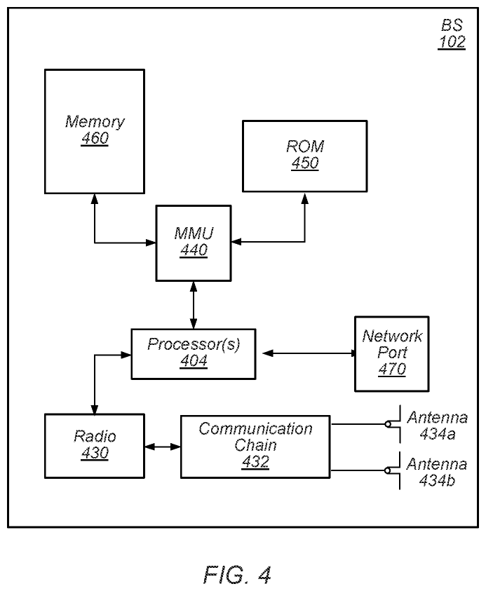

### FIG. 4—Block Diagram of an Exemplary Base Station

FIG. 4 illustrates a block diagram of an exemplary base station 102, according to some embodiments. It is noted that the base station of FIG. 4 is merely one example of a possible base station. As shown, the base station 102 may include processor(s) 404 which may execute program instructions for the base station 102. The processor(s) 404 may also be coupled to memory management unit (MMU) 440, which may be configured to receive addresses from the processor(s) 404 and translate those addresses to locations in memory (e.g., memory 460 and read only memory (ROM) 450) or to other circuits or devices.

The base station 102 may include at least one network port 470. The network port 470 may be configured to couple to a telephone network and provide a plurality of devices, such as UE devices 106, access to the telephone network as described above in FIGS. 1 and 2. The network port 470 (or an additional network port) may also or alternatively be configured to couple to a cellular network, e.g., a core network of a cellular service provider. The core network may provide mobility related services and/or other services to a plurality of devices, such as UE devices 106. In some cases, the network port 470 may couple to a telephone network via the core network, and/or the core network may provide a telephone network (e.g., among other UE devices serviced by the cellular service provider).

The base station 102 may include at least one antenna 434, and possibly multiple antennas, (e.g. illustrated by antennas 434a and 434b) for performing wireless communication with mobile devices and/or other devices. Antennas 434a and 434b are shown by way of example, and base station 102 may include fewer or more antennas. Overall, the one or more antennas, which may include antenna 434a and/or antenna 434b, are collectively referred to as antenna(s) 434. Antenna(s) 434 may be configured to operate as a wireless transceiver and may be further configured to communicate with UE devices 106 via radio circuitry 430. The antenna(s) 434 may communicate with the radio circuitry 430 via communication chain 432. Communication chain 432 may be a receive chain, a transmit chain or both. The radio circuitry 430 may be designed to communicate via various wireless telecommunication standards, including, but not limited to, LTE, LTE-A, 5G-NR (or NR for short), WCDMA, CDMA2000, etc. The processor(s) 404 of the base station 102 may be configured to implement part or all of the methods described herein, e.g., by executing program instructions stored on a memory medium (e.g., a non-transitory computer-readable memory medium), for base station 102 to implement control signaling that enhances the reliability of physical control channel (e.g. PDCCH) transmission and reception, as disclosed herein. Alternatively, the processor(s) 404 may be configured as a programmable hardware element, such as an FPGA (Field Programmable Gate Array), or as an ASIC (Application Specific Integrated Circuit), or a combination thereof. In the case of certain RATs, for example Wi-Fi, base station 102 may be designed as an access point (AP), in which case network port 470 may be implemented to provide access to a wide area network and/or local area network (s), e.g. it may include at least one Ethernet port, and radio 430 may be designed to communicate according to the Wi-Fi standard. Base station 102 may operate according to the various methods and embodiments as disclosed herein to provide control signaling for enhanced physical control channel (e.g. PDCCH) reliability.

### FIG. 5—Block Diagram of Exemplary Cellular Communication Circuitry

FIG. 5 illustrates an exemplary simplified block diagram illustrative of cellular controller 352, according to some embodiments. It is noted that the block diagram of the cellular communication circuitry of FIG. 5 is only one example of a possible cellular communication circuit; other circuits, such as circuits including or coupled to sufficient antennas for different RATs to perform uplink activities using separate antennas, or circuits including or coupled to fewer antennas, e.g., that may be shared among multiple RATs, are also possible. According to some embodiments, cellular communication circuitry 352 may be included in a communication device, such as communication device 106 described above. As noted above, communication device 106 may be a user equipment (UE) device, a mobile device or mobile station, a wireless device or wireless station, a desktop computer or computing device, a mobile computing device (e.g., a laptop, notebook, or portable computing device), a tablet and/or a combination of devices, among other devices.

The cellular communication circuitry 352 may couple (e.g., communicatively; directly or indirectly) to one or more antennas, such as antennas 335a-b and 336 as shown. In some embodiments, cellular communication circuitry 352 may include dedicated receive chains (including and/or coupled to (e.g., communicatively; directly or indirectly) dedicated processors and/or radios) for multiple RATs (e.g., a first receive chain for LTE and a second receive chain for 5G NR). For example, as shown in FIG. 5, cellular communication circuitry 352 may include a first modem 510 and a second modem 520. The first modem 510 may be configured for communications according to a first RAT, e.g., such as LTE or LTE-A, and the second modem 520 may be configured for communications according to a second RAT, e.g., such as 5G NR.

As shown, the first modem 510 may include one or more processors 512 and a memory 516 in communication with processors 512. Modem 510 may be in communication with a radio frequency (RF) front end 530. RF front end 530 may include circuitry for transmitting and receiving radio signals. For example, RF front end 530 may include receive circuitry (RX) 532 and transmit circuitry (TX) 534. In some embodiments, receive circuitry 532 may be in communication with downlink (DL) front end 550, which may include circuitry for receiving radio signals via antenna 335a.

Similarly, the second modem 520 may include one or more processors 522 and a memory 526 in communication with processors 522. Modem 520 may be in communication with an RF front end 540. RF front end 540 may include circuitry for transmitting and receiving radio signals. For example, RF front end 540 may include receive circuitry 542 and transmit circuitry 544. In some embodiments, receive circuitry 542 may be in communication with DL front end 560, which may include circuitry for receiving radio signals via antenna 335b.

In some embodiments, a switch 570 may couple transmit circuitry 534 to uplink (UL) front end 572. In addition, switch 570 may couple transmit circuitry 544 to UL front end 572. UL front end 572 may include circuitry for transmitting radio signals via antenna 336. Thus, when cellular communication circuitry 352 receives instructions to transmit according to the first RAT (e.g., as supported via the first modem 510), switch 570 may be switched to a first state that allows the first modem 510 to transmit signals according to the first RAT (e.g., via a transmit chain that includes transmit circuitry 534 and UL front end 572). Similarly, when cellular communication circuitry 352 receives instructions to transmit according to the second RAT (e.g., as supported via the second modem 520), switch 570 may be switched to a second state that allows the second modem 520 to transmit signals according to the second RAT (e.g., via a transmit chain that includes transmit circuitry 544 and UL front end 572).

As described herein, the first modem 510 and/or the second modem 520 may include hardware and software components for implementing any of the various features and techniques described herein. The processors 512, 522 may be configured to implement part or all of the features described herein, e.g., by executing program instructions stored on a memory medium (e.g., a non-transitory computer-readable memory medium). Alternatively (or in addition), processors 512, 522 may be configured as a programmable hardware element, such as an FPGA (Field Programmable Gate Array), or as an ASIC (Application Specific Integrated Circuit). Alternatively (or in addition) the processors 512, 522, in conjunction with one or more of the other components 530, 532, 534, 540, 542, 544, 550, 570, 572, 335 and 336 may be configured to implement part or all of the features described herein.

In addition, as described herein, processors 512, 522 may include one or more processing elements. Thus, processors 512, 522 may include one or more integrated circuits (ICs) that are configured to perform the functions of processors 512, 522. In addition, each integrated circuit may include circuitry (e.g., first circuitry, second circuitry, etc.) configured to perform the functions of processors 512, 522.

In some embodiments, the cellular communication circuitry 352 may include only one transmit/receive chain. For example, the cellular communication circuitry 352 may not include the modem 520, the RF front end 540, the DL front end 560, and/or the antenna 335b. As another example, the cellular communication circuitry 352 may not include the modem 510, the RF front end 530, the DL front end 550, and/or the antenna 335a. In some embodiments, the cellular communication circuitry 352 may also not include the switch 570, and the RF front end 530 or the RF front end 540 may be in communication, e.g., directly, with the UL front end 572.

### PDCCH Decoding

As previously mentioned, control information—used in support of the transmission of DL and UL transport channels—is typically transmitted in (or over) PDCCH and contains DL resource assignment and UL grant information. The UE may decode the PDCCH based on the configuration of search space (SS) and control channel resource set (CORESET). The PDCCH may be transmitted in the common search space and/or in a device-specific (or UE-specific) search space. Common control information for all UEs is typically transmitted in a PDCCH in the common search space. UE-specific control information is typically transmitted in a PDCCH in a UE-specific search space. A CORESET represents a set of physical resources (e.g. a specific area on a downlink resource grid) and a set of parameters used to carry PDCCH/DCI. It may be considered the equivalent to an LTE PDCCH area (the first 1, 2, 3 and/or 4 OFDM symbols in a subframe), but while in an LTE PDCCH region the PDCCH is spread across the whole channel bandwidth, the NR CORESET region is localized to a specific region in the frequency domain. Use of the bandwidth may include the use of subunits designated as carrier bandwidth parts (BWPs). A BWP is a contiguous set of physical resource blocks selected from a contiguous subset of the common resource blocks for a given numerology on a given carrier. For downlink, the UE may be configured with up to a specified number of carrier BWPs (e.g. four BWPs), with only one BWP per carrier active at a given time. For uplink, the UE may similarly be configured with up to several (e.g. four) carrier BWPs, with only one BWP per carrier active at a given time. If a UE is configured with a supplementary uplink, then the UE may be additionally configured with up to the specified number (e.g. four) of carrier BWPs in the supplementary uplink, with only one carrier BWP active at a given time.

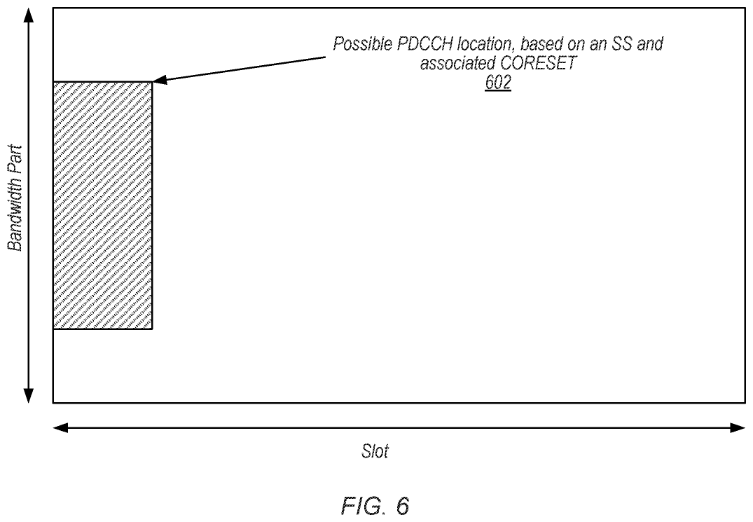

FIG. 6 shows an exemplary diagram illustrating a possible PDCCH location based on an SS and its associated CORESET. The frequency location, number of symbols, and TCI state are all configured by the CORESET, while the slot and the starting symbol index are configured by the SS. The SS and CORESET are typically configured by radio resource control (RRC) signaling. The UE may determine the time and frequency resource(s) and beam assigned to or designated for the PDCCH based on the SS and CORESET. The SS is used to determine the slot, while the CORESET provides the frequency resource information, symbol duration indication, and transmission and configuration indication (TCI). The TCI provides (or indicates) the beam related information, and may be configured by RRC or the media access control control-element (MAC CE) for each CORESET.

Enhancing the reliability of PDCCH transmission and reception has been an ongoing concern, and at least one enhancement being considered is the transmission and reception of PDCCH with (or using) multiple beam pairs. Thus, even if one beam pair is blocked, another beam pair may still provide reliable performance. However, the reception of PDCCH with multiple beam pairs also presents certain challenges. For example, it requires control signaling that supports multi-beam based PDCCH transmission and reception. In addition, a UE has to identify the TCI states to receive PDCCH from multiple beams, based on a certain mapping of the TCI states and the time/frequency resource(s) of a PDCCH transmission.

### Control Signaling for Enhanced PDCCH Reliability

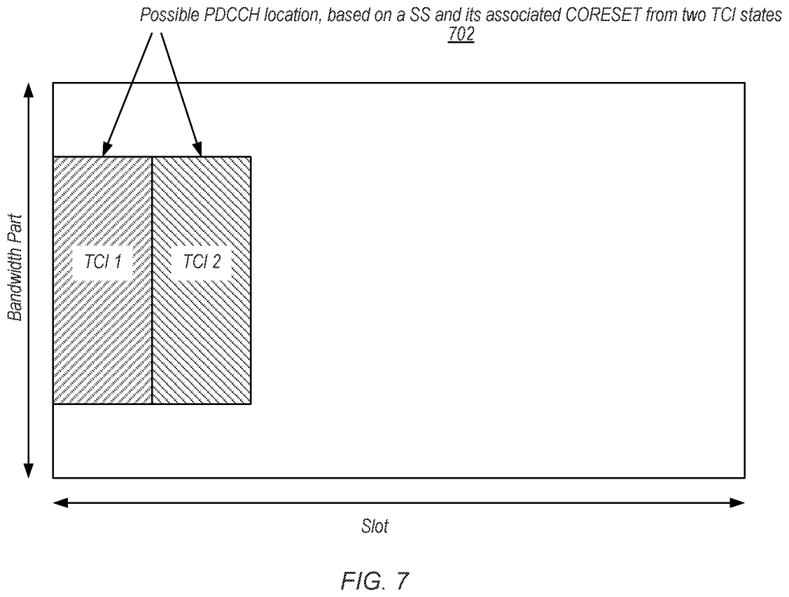

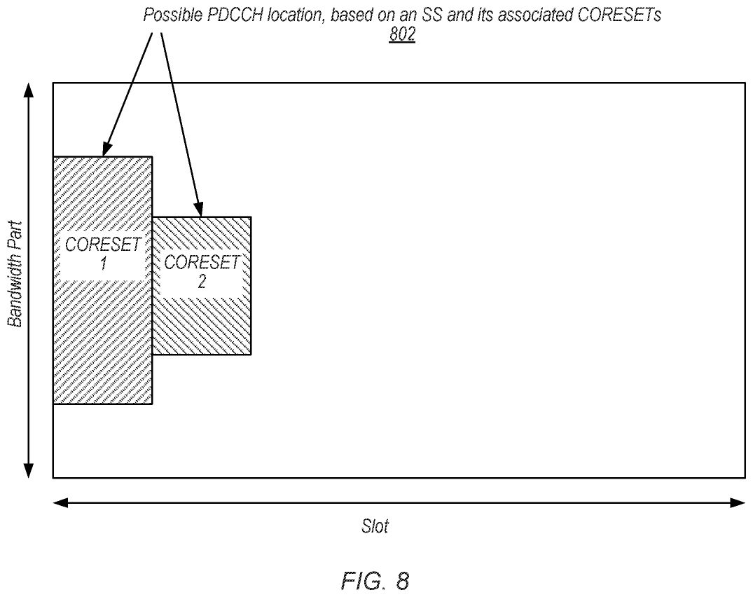

In some embodiments, up to a specified number N (N>1) TCI states may be configured for a CORESET. It should be noted that the terms “TCI” and “TCI state” are used interchangeably to refer to a given set or group of parameters provided as TCI, for example to indicate quasi co-location (QCL) relationships between antenna ports used for downlink communication with a UE. In some embodiments, one SS may be mapped to up to a specified number N (N>1) CORESETs. FIG. 7 shows an exemplary diagram illustrating a possible PDCCH location, based on an SS and its associated CORESET with multiple transmission configuration indication (TCI) states configured for a CORESET (702), while FIG. 8 shows an exemplary diagram illustrating a possible PDCCH location, based on an SS and its associated CORESETs with one SS mapped to multiple CORESETs (802). As indicated in FIG. 7, a PDCCH may be transmitted over the same BWP over multiple beams as defined by two TCI states (N=2). As indicated in FIG. 8, a PDCCH may be transmitted over the same BWP over multiple beams carried by different CORESETs as defined by one SS mapped to two CORESETs (N=2).

### FIG. 7

With respect to FIG. 7, the MAC CE may activate up to a specified number N (in the example N=2), TCI states for a CORESET. The specified number (N) of TCI states may be selected from a TCI states list configured in a CORESET by RRC. As a further extension, a MAC CE may activate up to a specified number (N) of TCI states for a CORESET with the same identifier (ID) in a group of serving cells. To put it another way, the TCI states may be activated in multiple serving cells for a CORESET having a specific ID, where in each serving cell the TCI states are activated for the CORESET having that specific ID. For example, CORESETs with CORESET-ID 1 and 2 may be configured in a first serving cell while CORESETs with CORESET-ID 1, 2, and 3 may be configured in a second serving cell. The base station (e.g. gNB) may then activate, via a MAC CE, specific TCI states, e.g. TCI states 4 and 5 for all CORESETs with CORESET-ID 1 in both the first and second serving cells. Alternatively, the MAC CE may activate up to a specified number (N) of TCI states for all CORESETs in a group of serving cells. The group of serving cells may be configured by (or via) RRC signaling as determined by or corresponding to UE capability. Accordingly, in some embodiments, one PDCCH may be transmitted using the time and frequency resources indicated by the SS and its associated CORESET, based on the specified number (N) of TCI states. In some embodiments a PDCCH may be repeatedly transmitted using the time and frequency resources indicated by the SS and its associated CORESET, with each repetition or transmission of the PDCCH associated with a TCI state. To put it another way, multiple instances of the PDCCH may be received using the time and frequency resources indicated by the SS and its associated CORESET, with each instance associated with a different TCI state. In some embodiments, different beams may be used for different resource elements for transmitting a single instance of the PDCCH. For example, different TCI states may be applied for the time and/or frequency resources indicated by the SS and its associated CORESET for a single PDCCH instance.

The specified number (N) of TCI states may be multiplexed according to the following options:
First option: the specified number (N) of TCI states are multiplexed in a frequency division multiplex (FDM) manner (different beams corresponding to different resource element groups; REGs);
Second option: the specified number (N) of TCI states are multiplexed in a time division multiplex (TDM) manner; and
Third option: the specified number (N) of TCI states are multiplexed in a spatial division multiplex (SDM) manner.

The multiplexed schemes may be configured by (or via) higher layer signaling (e.g. RRC signaling) or determined by some parameters configured in a CORESET, e.g. in precoder granularity and/or duration. If the precoder granularity is configured to be the same as (or is commensurate with) a resource element group (REG) bundle (e.g. the granularity is the same as or is commensurate with the REG level), an FDM scheme may be applied. If the precoder granularity is configured to be all contiguous resource blocks (RBs), e.g. wideband, and the duration is configured with more than one symbol, a TDM scheme may be applied with a different TCI state applied for each different symbol. If the precoder granularity is configured to be all contiguous RBs (e.g. wideband) and the duration is configured with only one symbol, one TCI state may be indicated or an SDM scheme may be applied.

With respect to the first option above (FDM scheme), the following cases may be implemented to define the mapping of the TCI to frequency resources (TCI-to-frequency-resource mapping):
Case 1: The mapping may be determined by the value of the precoder granularity. If the precoder granularity is configured to be the same as the REG level, the even REGs may be associated with a first TCI and the odd REGs may be associated with a second TCI. If the precoder granularity is configured as all contiguous RBs (e.g. wideband), the first half of REGs and/or RBs may be associated with a first TCI and the second half of (or remaining) REGs and/or RBs may be associated with the second TCI. Alternatively, this may be considered as an error case; and
Case 2: The granularity of frequency resources mapped to the TCI may be separately configured by another RRC parameter. That is, an RRC parameter may be introduced and used to configure the granularity for the TCI mapping.

With respect to the second option above (TDM scheme), the following cases may be implemented to define the mapping of the TCI to time resources (TCI-to-time-resource mapping):
Case 1: A first TCI may be mapped to the first half of symbols and a second TCI may be mapped to the second half of the symbols (or to the remaining symbols). In some embodiments, the first TCI may be mapped to a specified predetermined number of symbols based on a total number of available symbols, while the remaining symbols may be mapped to the second TCI;
Case 2: Each TCI may be mapped to each symbol in turns. For example, in some embodiments, the first TCI may be mapped to even symbols and the second TCI state may be mapped to odd symbols.
Case 3: The mappings for Case 1 and Case 2 may be configured by (or via) RRC signaling; and
Case 4: The associated TCI for each symbol may be configured by (or via) RRC signaling. For example, if there are three symbols, a syntax map may be introduced, and a first value (e.g. 0) may indicate a first TCI state, and a second value (e.g. 1) may indicate a second TCI state.

With respect to the third option above (SDM scheme), when the precoder granularity is configured to be all contiguous RBs (e.g. wideband) and the duration is configured with only one symbol, the following cases may be implemented:
Case 1: a specified number (N) of demodulation reference signal (DMRS) ports may be supported, where each TCI is mapped to one DMRS port; and
Case 2: different TCIs may be mapped to different scramble IDs used to generate the DMRS sequence. A UE may be configured with up to a specified number (N) of scramble IDs, and the mapping between a TCI state and corresponding scramble ID may be configured by (or via) RRC signaling.

### FIG. 8

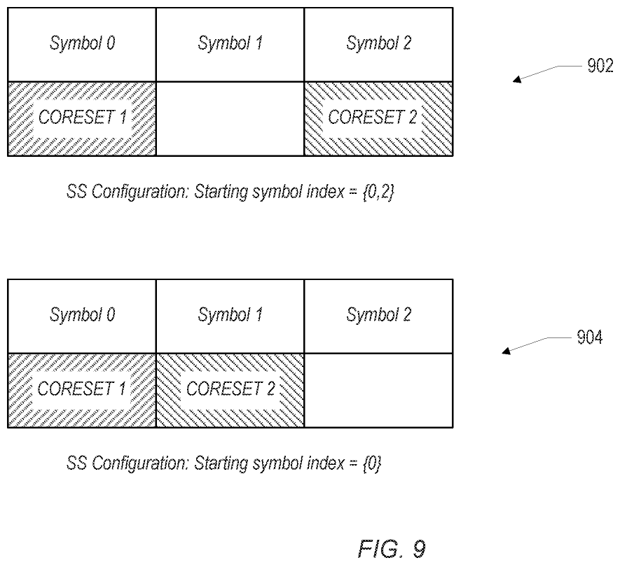

With respect to FIG. 8, the base station (e.g. gNB) may configure more than one CORESET-ID for each SS by (or via) RRC signaling. In some embodiments, the configuration may be applied for a UE specific SS. In some embodiments, the configuration may be applied for both a UE specific SS and cell specific SS. The associated CORESETs may be multiplexed in an FDM, TDM and/or SDM manner. For FDM, the frequency resources configured for the CORESETs may be non-overlapping (e.g. different RBs may be associated with different CORESETs) and the CORESETs may share the same starting symbol index configured by the SS. For TDM, two cases may be implemented:
Case 1: the starting symbol index for each associated CORESET may be configured separately in a SS, which is illustrated as 902 in FIG. 9; and
Case 2: the starting symbol index may be determined by the duration of each CORESET as well as the CORESET-ID, which is illustrated as 904 in FIG. 9. For example, the first symbol is used for the first CORESET, the second symbol is used for the second CORESET, etc.
   For SDM, different scramble IDs may be configured for different CORESETs. Some other parameters that may result in a different DCI format may be configured to be the same for the associated CORESETs.

The multiplexing schemes for the CORESETs may be configured by RRC signaling or determined by specific (e.g. dedicated) RRC parameters in CORESET, e.g. “frequency domain resources” parameter and/or “duration” parameter. In some embodiments, if the frequency domain resources for the CORESETs are orthogonal (frequency resources are non-overlapping), an FDM scheme may be applied. Otherwise, for overlapping frequency resources, a TDM scheme may be applied. In some embodiments, if the frequency domain resources for the CORESETs are not orthogonal (e.g. they are overlapping), if the sum of the duration from the associated CORESETs is below a specified time duration, a TDM scheme may be applied, otherwise, this may be considered as an error case.

It is well understood that the use of personally identifiable information should follow privacy policies and practices that are generally recognized as meeting or exceeding industry or governmental requirements for maintaining the privacy of users. In particular, personally identifiable information data should be managed and handled so as to minimize risks of unintentional or unauthorized access or use, and the nature of authorized use should be clearly indicated to users.

Embodiments of the present invention may be realized in any of various forms. For example, in some embodiments, the present invention may be realized as a computer-implemented method, a computer-readable memory medium, or a computer system. In other embodiments, the present invention may be realized using one or more custom-designed hardware devices such as ASICs. In other embodiments, the present invention may be realized using one or more programmable hardware elements such as FPGAs.

In some embodiments, a non-transitory computer-readable memory medium (e.g., a non-transitory memory element) may be configured so that it stores program instructions and/or data, where the program instructions, if executed by a computer system, cause the computer system to perform a method, e.g., any of a method embodiments described herein, or, any combination of the method embodiments described herein, or, any subset of any of the method embodiments described herein, or, any combination of such subsets.

In some embodiments, a device (e.g., a UE) may be configured to include a processor (or a set of processors) and a memory medium (or memory element), where the memory medium stores program instructions, where the processor is configured to read and execute the program instructions from the memory medium, where the program instructions are executable to implement any of the various method embodiments described herein (or, any combination of the method embodiments described herein, or, any subset of any of the method embodiments described herein, or, any combination of such subsets). The device may be realized in any of various forms.

Any of the methods described herein for operating a user equipment (UE) or device may be the basis of a corresponding method for operating a base station or appropriate network node, by interpreting each message/signal X received by the UE in the downlink as message/signal X transmitted by the base station/network node, and each message/signal Y transmitted in the uplink by the UE as a message/signal Y received by the base station/network node.

Although the embodiments above have been described in considerable detail, numerous variations and modifications will become apparent to those skilled in the art once the above disclosure is fully appreciated. It is intended that the following claims be interpreted to embrace all such variations and modifications.

1. An apparatus comprising:
a processor configured to cause a device to perform operations comprising:
receiving a physical control channel using multiple beam pairs, wherein time and frequency resources used to carry the physical control channel are based on a search space and its associated one or more control channel resource sets (CORESETs), and wherein receiving the physical control channel includes receiving the physical control channel according to one of:
a specified first number of transmission configuration indication (TCI) states configured for a corresponding CORESET of the associated one or more CORESETs; or
the search space mapped to a specified second number of CORESETs of the associated one or more CORESETs.

2. The apparatus of claim 1, wherein the specified first number of TCI states are selected from a TCI states list configured in the corresponding CORESET via radio resource control.

3. The apparatus of claim 1, wherein the specified first number of TCI states is activated by a media access control (MAC) control element (CE).

4. The apparatus of claim 3, wherein the MAC CE activates the specified first number of TCI states for one of:
the corresponding CORESET with a same ID in each cell of a group of serving cells; or
all CORESETs in the group of serving cells.

5. The apparatus of claim 4, wherein the group of serving cells are configured via radio resource control signaling as determined by capabilities of the device.

6. The apparatus of claim 1, wherein receiving the physical control channel according to the specified first number of TCI states includes one of:
receiving the physical control channel using the time and frequency resources indicated by the search space and the corresponding CORESET, based on the specified first number of TCI states; or
receiving multiple instances of the physical control channel in the time and frequency resources indicated by the search space and the corresponding CORESET, wherein each instance of the multiple instances is associated with a different TCI state of the specified first number of TCI states.

7. The apparatus of claim 1, wherein the specified first number of TCI states are multiplexed according to one of:
frequency division multiplexing (FDM);
time division multiplexing (TDM); or
spatial division multiplexing (SDM).

8. The apparatus of claim 7, wherein any one or more of the FDM, TDM, or SDM are configured via one or more of:
higher layer signaling; or
parameters configured in the corresponding CORESET.

9. The apparatus of claim 8, wherein the parameters comprise one or more of:
precoder granularity; or
duration.

10. The apparatus of claim 9, wherein the specified number of TCI states are multiplexed according to one of:
FDM when the precoder granularity is commensurate with a resource element group level;
TDM when the precoder granularity represents a contiguous resource block (RB) configuration and the duration is configured with more than one symbol; or
SDM when the precoder granularity represents a contiguous RB configuration and the duration is configured with one symbol.

11. The apparatus of claim 9, wherein when the precoder granularity is commensurate with a resource element group (REG) level, even REGs are associated with a first TCI state of the specified first number of TCI states, and odd REGs are associated with a second TCI state of the specified first number of TCI states.

12. The apparatus of claim 1, wherein a granularity of frequency resources mapped to a TCI is configured by a radio resource control parameter.

13. The apparatus of claim 1, wherein a first TCI state of the specified first number of TCI states is mapped to a first number of symbols of the time resources and a second TCI state of the specified first number of TCI states is mapped to remaining symbols of the time resources.

14. The apparatus of claim 1, wherein a first TCI state of the specified first number of TCI states is mapped to even symbols of the time resources and a second TCI state of the specified first number of TCI states is mapped to odd symbols of the time resources.

15. The apparatus of claim 1, wherein each TCI state of the specified first number of TCI states is mapped to a respective demodulation reference signal (DMRS) port of a specified number of DMRS ports, wherein the specified number is the first number.

16. The apparatus of claim 1, wherein the search space is one or more of:
device specific search space; or
cell specific search space.

17. The apparatus of claim 1, wherein a starting symbol of the time resources for each of the specified second number of CORESETs is configured separately in the search space.

18. The apparatus of claim 1, wherein a starting symbol index of the time resources is determined by a duration of each of the specified second number of CORESETs and a corresponding CORESET identifier.

19. A device comprising:
radio circuitry configured to facilitate wireless communications of the device; and
a processor communicatively coupled to the radio circuitry and configured to cause the device to:
receive a physical control channel using multiple beam pairs, wherein time and frequency resources used to carry the physical control channel are based on a search space and its associated one or more control channel resource sets (CORESETs), and wherein the physical control channel is received according to one of:
a specified first number of transmission configuration indication (TCI) states configured for a corresponding CORESET of the associated one or more CORESETs; or
the search space mapped to a specified second number of CORESETs of the associated one or more CORESETs.

20. A non-transitory memory element storing programming instructions executable by a processor to cause a device to:
receive a physical control channel using multiple beam pairs, wherein time and frequency resources used to carry the physical control channel are based on a search space and its associated one or more control channel resource sets (CORESETs), and wherein the physical control channel is received according to one of:
a specified first number of transmission configuration indication (TCI) states configured for a corresponding CORESET of the associated one or more CORESETs; or
the search space mapped to a specified second number of CORESETs of the associated one or more CORESETs.
